(19) United States
(12) Patent Application Publication
(10) Pub. No.: US 2026/0307778 A1
(43) Pub. Date: Oct. 8, 2026

(54) VARIABLE-PITCH ASSEMBLY FOR A TURBOMACHINE FAN

(71) Applicant: SAFRAN AIRCRAFT ENGINES, Paris (FR)

(72) Inventors: Vincent François Georges MILLIER, Moissy-Cramayel (FR); Julien Fabien Patrick BECOULET, Moissy-Cramayel (FR); Elias Jonathan SCHÖNLEBER, Moissy-Cramayel (FR)

(73) Assignee: SAFRAN AIRCRAFT ENGINES, Paris (FR)

(21) Appl. No.: 19/472,262

(22) PCT Filed: Apr. 3, 2024
(86) PCT No.: PCT/FR2024/050425

§ 371 Date: Oct. 3, 2025

(30) Foreign Application Priority Data
Apr. 4, 2023 (FR) FR2303343

(51) Int. Cl. B64C 11/06; F01D 5/30; F01D 25/28

(52) U.S. Cl. CPC B64C 11/06; F01D 5/30; F01D 25/28

(57) ABSTRACT

A variable-setting assembly for a turbomachine fan, including: a hub comprising hub sockets each internally delimiting a radial opening in relation to the longitudinal axis of rotation of the hub, for each socket: a force take-up device installed through the opening and clamped against an inner surface of the socket disposed parallel to a radial axis of the socket a blade support/root supporting a blade, able to pivot about the axis and engaged in the socket through its opening inside the blade force take-up device and a device for locking the blade support/root inside the force take-up device.

### TECHNICAL FIELD

This summary relates to a variable-setting assembly for a turbomachine fan and a turbomachine fan comprising such an assembly.

The invention is applicable to aeronautical turbomachines.

### PRIOR ART

Certain turbojet engines comprise a variable-setting fan in which a change of setting or orientation of the fan blades is done in order to manage the thrust of the turbojet engine appropriately according to the flight phases of the aircraft equipped with such a turbojet engine.

A variable-setting fan generally comprises a hub which extends circumferentially around a longitudinal axis of rotation of the fan and the blades of the fan are mounted at the periphery of the hub. More specifically, the hub comprises a plurality of hub sockets circumferentially distributed at the periphery of the hub and which each include an opening oriented radially in relation to the longitudinal axis. The blades are each mounted at their root in a hub socket by way of a pivot receiving the root of the blade and equipped with ball bearings making it possible to take up all the forces to which the operating blade is subject.

The assembly known as the bearing cartridge which is formed by the pivot of a blade and the rolling bearings associated with the blade pivot is mounted via the inside in a socket of the hub, while the blade is mounted on the pivot from the outside of the hub socket. In general, the radial retainment of the blades is provided by the shape of the blade root and of the recess housing it, the pivot and its balls, the hub into which the pivot is incorporated and the outer casing of the fan. The hub socket includes, internally, a radial stop which makes it possible to ensure the retainment of the pivot in the radial position when the fan is operated, particularly in order to avoid any radial displacement of the assembly (pivot and bearings), away from the longitudinal axis, under the effect of the centrifugal forces due to the rotation of the fan. A mechanism internal to the hub makes it possible to pivot each blade pivot on command and therefore the blade carried by the pivot.

During maintenance operations on the assembly formed by the pivot and the associated bearings (for various reasons such as for example after ingestion of a bird), the architecture described above requires the operation to be performed from the inside of the hub. To do this, it is therefore necessary to dismount the aerodynamic cone (known as a “spinner”) located upstream of the fan blades and the drain cap disposed inwardly in relation to the cone, then to remove the entire pivot mechanism of each blade pivot. The bulk of the area inward of the hub makes it difficult to perform these dismounting operations without running the risk of damaging the parts.

However, from the patent FR 3 129 428 A1 a variable-setting fan assembly is known which is mounted through the radial opening of the hub socket, from the outside thereof, which greatly simplifies maintenance operations.

This variable-setting fan assembly comprises a blade force take-up device which is first inserted into the hub socket to be clamped against an inner surface of the socket, then the blade pivot is engaged inside the blade force take-up device. The blade pivot is then locked in the radial position in the hub socket from the inside of this latter. More specifically, provision is made for a segment in two half-shells at the bottom part of the pivot to ensure the radial stopping of the pivot. This segment is retained in position by the pivot control eccentric of the blade pivot which ensures the variable setting of the blade. This eccentric is located below the blade pivot and is therefore disposed in a radial position nearer to the engine axis than the blade pivot and the hub socket.

This configuration of an assembly with variable fan setting simplifies mounting and dismounting operations insofar as the assembly can be mounted and removed via the outside of the hub socket.

However, to unlock the pivot during a maintenance operation, it is necessary to access the inside of the hub in order to disengage the pivot control eccentric of the blade pivot from its actuating linkage, then to remove the segment in two half-shells.

In view of the above it would therefore be useful to remedy at least one of the drawbacks set out above.

### SUMMARY OF THE INVENTION

The invention thus has as subject a variable-setting assembly for a turbomachine fan, comprising:
a hub extending circumferentially around a longitudinal axis X-X′ of rotation of the hub and which comprises at least one hub socket internally delimiting an opening oriented radially in relation to the longitudinal axis,
a fan blade force take-up device which is attached in said at least one hub socket and intended to take up the forces of a fan blade mounted in said at least one hub socket,
a fan blade support or a fan blade root which is able to pivot on command about a radial axis A passing through the radial opening of the hub socket and configured to be engaged through this opening, inside the blade force take-up device, and to then abut along the radial axis A against an inner element of the blade force take-up device,
a device for clamp-locking the blade support or the blade root which is positioned around this latter, at a radially outward position with respect to a radially inward position, nearer to the longitudinal axis, of the inner stop element, and which is attached to the blade force take-up device in such a way as to clamp around the blade support or the blade root and to retain it abutting along the radial axis A against the inner stop element,
   the blade force take-up device comprising an intermediate interface part which extends along the radial axis between a radially outward position and a radially inward position and which includes, at its radially outward position, the inner stop element, the blade support or the blade root including, on the one hand, an elongated part which extends along the radial axis and which is disposed against at least one radial axis extension part of an inner surface of the intermediate interface part and, on the other hand, a part which extends transversely in relation to the radial axis A and which is engaged against the inner stop element,
   the blade force take-up device comprising an assembly formed of at least one rolling bearing in a radially outward position and a second rolling bearing in a radially inward position, the first bearing including an inner bush which extends along the radial axis A and the second bearing including an inner bush which extends along the radial axis A, the intermediate interface part being clamped between the inner bushes of the two bearings.

The assembly defined above includes a device for clamp-locking the blade support or the blade root which is in a position radially outward of the hub socket and of the blade force take-up device, which makes it accessible from the opening of the hub socket. It is therefore no longer necessary to have access through the inside of the hub, to unlock the blade support or the blade root, which simplifies the operations of unlocking a variable-setting fan assembly of the type described above and therefore the associated maintenance operations. The locking operation is also simplified.

Moreover, the architecture of the assembly defined above and particularly of the hub socket, of the blade support and of the blade force take-up device is designed so that these components are mounted from the outside of the hub socket (the blade force take-up device is first put in place in the socket, from the outside of the socket, before installing the blade support therein) and not via the inside of the socket. This greatly simplifies subsequent interventions on constituent components of the assembly since it is then enough to remove them via the outside of the socket without needing to access the inside of his socket, after having dismounted a large inner part of the fan.

According to other possible features:
the hub extends circumferentially around a longitudinal axis X-X′ of rotation of the hub and comprises a plurality of hub sockets circumferentially distributed over an outer periphery of the hub, each hub socket internally delimiting an opening oriented radially in relation to the longitudinal axis and which is able to put a peripheral area Ze radially outward of the hub socket, located away from the longitudinal axis, in communication with a peripheral area Zi radially inward of the hub socket, which is nearer to the longitudinal axis, a blade force take-up device being configured to be put in place in each hub socket through the opening of this latter, and clamped against an inner surface of the hub socket disposed substantially parallel to a radial axis A passing through the radial opening of the hub socket;
more specifically, the first bearing may include an inner bush which extends along the radial axis and comprise a first part in contact with an outer surface, opposite the inner surface, of the intermediate interface part and a second part which extends away from the longitudinal axis all the way to a radially outward position in relation to a radially inward position occupied by the transverse extension part of the blade support or of the blade root when this latter is engaged against the inner stop element, the clamp-locking device being configured to be locked by clamping onto the second part of the inner bush in such a way as to then, by clamping, bear along the radial axis against the transverse extension part of the blade support or of the blade root;
the inner bush of the first bearing comprises a part extending in a radially outward position and onto which the clamp-locking device is clamp-locked, the part of the inner bush having an inner thread on an inner surface oriented facing the blade support or the blade root, the clamp-locking device comprising a clamping nut in two parts disposed between the part of the inner bush and the blade support or the blade root, which is provided with an outer thread and is screwed onto the inner surface of the part of the inner bush by way of the two threads;
more specifically, the clamping nut, disposed between the part of the inner bush and the blade support or the blade root, then, when fully tightened on the inner surface of the part of the inner bush, bears along the radial axis against the transverse extension part of the blade support or of the blade root;
the clamp-locking device further comprises an anti-rotation member configured to prevent a rotation between the inner bush and the clamping nut;
the two parts of the clamping nut each include (particularly in an area located at a radially outward position in relation to an area located at a radially inward position of the concerned part and which bears along the radial axis against the transverse extension part of the blade support or of the blade root) a plurality of teeth spaced apart from one another (the teeth may extend around a circumference of the clamping nut taken transversely with respect to the radial axis, when the two parts meet), the anti-rotation member being disposed between two consecutive teeth;
the clamp-locking device further comprises a stopping member which retains the anti-rotation member in position between two consecutive teeth while being attached to the second part of the inner bush near its upper radial position;
the clamping nut in two parts includes elements configured to ensure the alignment in the radial position of the two parts of the nut, one with respect to the other in order to ensure the alignment of the portions of the outer thread provided on the two parts of the nut;
the first rolling bearing is disposed in a transverse position furthest from the socket radial axis A and configured to take up the radial and transverse forces transmitted by the blade, the second rolling bearing being disposed in a transverse position nearest to the socket radial axis A and configured to take up the transverse forces transmitted by the blade;
the blade force take-up device comprises a system for retaining in position, and clamping by wedge effect, the rolling bearing assembly that is positioned level with the socket opening, in a radial position further from the longitudinal axis than the first rolling bearing;
the system for retaining in position and clamping by wedge effect comprises, on the one hand, two segments in half-shells having inner conical mating surfaces interacting with clamping parts by way of outer conical mating surfaces of these latters, and, on the other hand, a clamping nut configured to bear, by way of outer conical mating surfaces on inner conical mating surfaces of the clamping parts, and thus exert, on the one hand, a transverse force on the clamping parts and the two segments in half-shells to put them so that they bear against the inner surface of the hub socket and, on the other hand, a radial clamping force on the first rolling bearing in the direction of the longitudinal axis X-X′;
the first rolling bearing includes an outer bush disposed in an outer transverse position further from the socket radial axis A than the transverse position of the balls of the first and second bearings and which, on the one hand, extend substantially parallel to the radial axis along the balls of the first rolling bearing and of the second rolling bearing and, on the other hand, bears against the second rolling bearing;
a clamping element of the second rolling bearing is disposed in an outward transverse position in relation to this second bearing and the outer bush of the first rolling bearing bears on this clamping element;
the second rolling bearing includes an inner bush disposed in an inward transverse position in relation to the radial position of the balls of the bearing, each of the inner bushes of the first rolling bearing and of the second rolling bearing is housed in a housing for which provision is made on a radially outward surface of the intermediate interface part;
the assembly includes an eccentric system for controlling the pivoting of the blade support or of the blade root which is configured to control the pivoting of the blade support or of the blade root about the socket radial axis, the system including an engagement part configured to be engaged in an engagement position with a lower part of the blade support or of the blade root which is opposite an upper part of the blade support disposed in a radially outward position in relation to the radially inward position of the lower part.

The invention also has the subject of a turbomachine fan which comprises a variable-setting assembly for a turbomachine fan as briefly set out above.

According to a feature, the fan comprises a plurality of fan blades each mounted on a blade support of a mounting module of a hub socket.

Another subject of the invention is a turbomachine comprising a fan as briefly set out above.

### BRIEF DESCRIPTION OF THE DRAWINGS

Other features and advantages of the subject of this summary will become apparent from the following description of embodiments, given by way of non-limiting example, with reference to the appended figures.

FIG. 1 is a partial schematic representation in perspective view of a turbomachine fan according to an embodiment of a according to the invention;

FIG. 2 is a partial schematic representation in axial section view of the fan partially shown in FIG. 1;

FIG. 3 is a magnified partial schematic representation of the module for mounting a fan blade incorporated into the hub socket of FIG. 2;

FIG. 4 schematically illustrates, in perspective view, the placement, in the hub socket, of certain components of the blade mounting module of FIG. 3.

FIG. 5A is a magnified schematic representation of a part of FIG. 4 in which the upper part of the blade root has been deliberately omitted for the sake of clarity;

FIG. 5B illustrates a first position in the assembly of the two half-nuts of a clamping nut according to a variant embodiment;

FIG. 5C illustrates a second position in the assembly according to the variant embodiment;

FIG. 5D illustrates a third position in the assembly according to the variant embodiment;

FIG. 5E illustrates a fourth position in the assembly according to the variant embodiment;

FIG. 6A illustrates the blade force take-up device mounted in the hub socket;

FIG. 6B illustrates the insertion of the blade root into the interface part;

FIG. 6C illustrates the end of the movement of insertion of the blade root into the interface part;

FIG. 6D illustrates the placement of the two parts of the clamping nut around the blade root;

FIG. 6E illustrates the interlocking of the two parts of the clamping nut with one another;

FIG. 6F illustrates the screwing of the two parts of the clamping nut;

FIG. 6G illustrates the placement of an anti-rotation member on the assembly of FIG. 6F;

FIG. 6H illustrates the placement of a stopping member on the anti-rotation member of FIG. 6G.

### DETAILED DESCRIPTION

The invention is applicable to any turbomachine equipped with at least one fan, ducted or not, the fan blades (ducted fan) or propeller blades (unducted fan) of which are equipped with a setting- or orientation-changing assembly, also known as a variable-setting assembly. The invention can also be used for stator vanes with variable setting. It may for example concern outlet guide vanes of the secondary flow which are positioned downstream of the fan blades. It may also concern flow straightening vanes in a compressor or guide vanes for the inlet flow of a compressor.

The following detailed description relates to an embodiment of a ducted fan of a turbomachine for an aircraft comprising an assembly with variable setting of the fan blades.

As shown on FIG. 1 and generally denoted by the reference 10, a fan comprises a plurality of blades, only one of which, 12, is partially shown.

The fan 10 comprises a hub 14 extending circumferentially around a longitudinal axis of rotation X-X′ of the hub and comprises a plurality of hub sockets 16 circumferentially distributed over an outer periphery of the hub.

Each hub 16 internally delimits an opening 16a oriented radially, along an axis A having a radial orientation in relation to the longitudinal axis X-X′. The hub sockets 16 are thus all oriented in the manner of a star in relation to the hub, each along a radial axis A. The radial opening 16a has a through section which extends perpendicularly to the radial axis A and is able to put a peripheral area Ze radially outward of the hub socket 16, located away from the longitudinal axis X-X′, in communication with a peripheral area Zi radially inward of the hub socket, which is nearer to the longitudinal axis than the area Ze. In other words, the hub 16 has a through opening 16a along the radial axis.

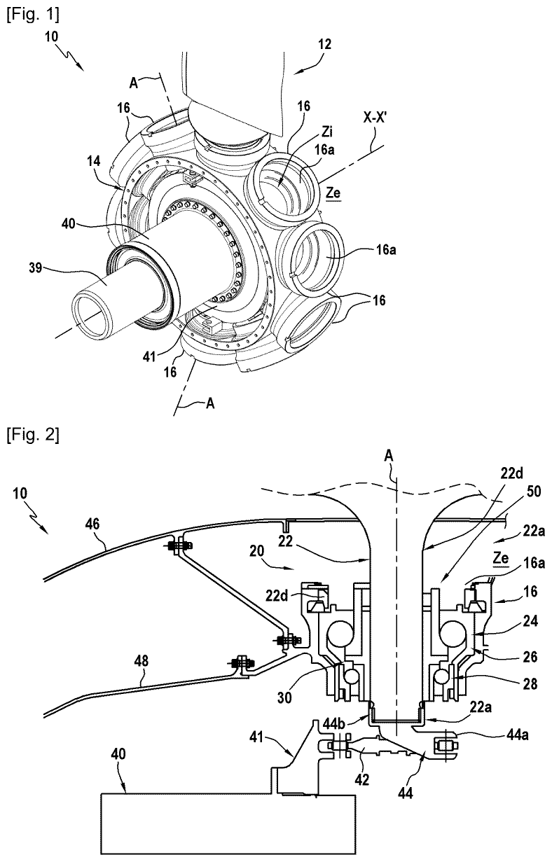

As shown on FIG. 1, the hub 14 includes in its central inner part, from the center outward, a control means here comprising a fixed piston 39 of a control actuator and the movable chamber 40 of this latter, as well as a connecting part 41 between this control actuator and linkages 42 illustrated on FIG. 2 and described hereinafter.

As shown on FIG. 1, a blade 12 is shown mounted in a hub socket 16. The other sockets are shown empty to avoid complicating the drawing but a blade is normally also mounted in each of them.

FIG. 2 shows, in axial section along the axis X-X′, a part of the fan which comprises a hub socket 16 into which is incorporated a module for mounting a fan blade 12. This module is part of a fan blade variable-setting assembly according to an embodiment of the invention which comprises the hub 14 and other modules for the other fan blades.

The fan blade mounting module comprises a blade force take-up device 24 which is intended to be directly in contact with a blade root 22. Alternatively, the blade force take-up device 24 can be in contact with a blade support or pivot intended to support a blade root (particularly for a mounting with a bulb-shaped blade root). In this latter case, the fan blade mounting module also comprises the blade support or pivot. The blade support includes an upper part in which a recess is fashioned which has the purpose of receiving the blade root and its attaching bulb. The upper part of the blade support generally forms a plate which overlooks a lower central pad of substantially cylindrical shape.

In the following description, the blade force take-up device 24 will be directly in contact with a blade root 22 and is configured to be put in place in the hub socket 16 through the radial opening 16a of this latter, from a peripheral area Ze radially outward of the socket (FIGS. 1 and 2). These configurations of blade mounting module (blade force take-up device 24) and of hub socket allow the module to be put in place from the outside of the hub, which makes it possible to simplify maintenance operations when the module is to be removed from the socket (from the outside of this socket) to access the inner components of the module. Similarly, the returning of the inspected, and where applicable repaired or replaced, module 34 to its place, is done from the outside of the hub 14. It is therefore no longer necessary to dismount the entire inner cowling of the fan and the inner mechanisms for controlling the blade pivoting. Significant time is thus saved and maintenance costs are greatly reduced. The risks of damage to the surrounding structures in place in the fan are also reduced. The mounting/dismounting from the top (on FIG. 2) also makes it possible to free up space under the module 34, for example, to house other parts therein.

More specifically, the retainment of the fan blade 12 in a fixed radial position is ensured by the retainment of the blade root 22 in the locked position in the blade force take-up device 24 (as described further on). Moreover, the blade root is guided by the blade force take-up device 24 for the setting of the blade pitch. The setting of the blade pitch is defined as equivalent to an angular orientation of the blade in relation to the radial axis A passing through the hub socket.

The blade root 22 is in particular able to pivot about the radial axis A of the hub socket 16 under the action of a mechanism which will be described further on and which interacts with a lower (radially inward) part 22a of the blade root 22 opening out along the radial axis A beyond the blade force take-up device 24, in a radially inner area of the hub. The lower part 22a is opposite an upper part 22b of the blade root 22 which is nearer to the radial opening 16a of the hub socket.

As more specifically shown on FIG. 2, provision is made for a system or mechanism with an eccentric for controlling the pivoting of the blade root 22 inside the hub 14, under the socket 16 (for example in a radially inward position, in proximity to the axis X-X′) and is configured to control the pivoting of the blade root 22 about the socket radial axis A and therefore its angular orientation.

More specifically, the eccentric system for controlling the pivoting of the blade root is configured to engage with the lower opening-out or protruding part 22a of the blade root in order to pivot this latter, and therefore the blade it supports, on command, by the desired angle of pivot for the flight phase in question.

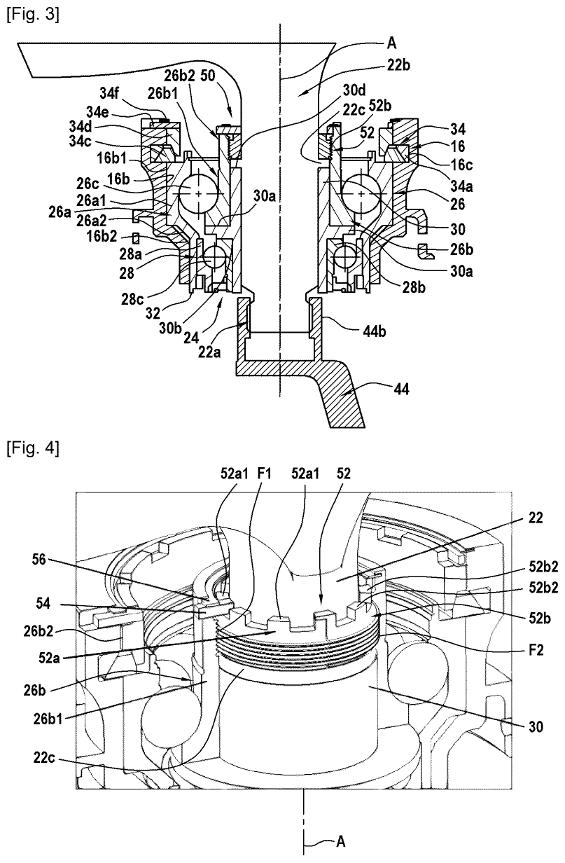

The pivot control system for example comprises the axial control actuator centered on the longitudinal axis X-X′ and described with reference to FIG. 1. This actuator comprises the axial rod 39 fixed with respect to the structures of the turbojet engine (FIG. 1) and the movable body or chamber 40. The pivot control system also comprises a coupling part 41, known as a synchronization ring, on which several linkages 42 are connected by one of their two opposing ends. One linkage is generally provided per blade support and per socket and is disposed in a radially inward position with respect to the socket. The other end of each linkage is connected to an end 44a of an eccentric-forming part 44, here of an overall elbow shape (though the shape of the part may vary), the opposite end 44b of which is mounted securely on the lower part 22a of the blade root 22. The end 44b is disposed around the protruding lower part 22a and forms an end or engagement part which is engaged with the protruding lower part 22a (on FIG. 3 the part 44 has been deliberately simplified with respect to the configuration of FIG. 2). More specifically, the inner part of the end or engagement part 44b is for example provided with inner splines which then engage by meshing with the recesses between the splines of complementary shape of the outer surface of the lower part 22a of the blade support 22 (in the manner of a gear), in an engagement position, to transmit the rotational movement communicated by the eccentric-forming part 44. The axial displacement of the movable body 40 drives the coupling part 41 in translation, and therefore the axial translation of the linkages 42, which pivots the part 44 and thus correspondingly modifies the angular orientation of the blade support and therefore of the blade.

The blade force take-up device 24, itself, forms a unit block which is mounted as a single piece, in front of the blade root 22, inside the hub socket 16 by passing through the radial opening 16a, from a peripheral area Ze outside of the socket.

The blade force take-up device 24 is put in place clamped against an inner surface 16b of the hub socket 16 (FIG. 3), a surface which is substantially disposed in a transverse position further away in relation to the radial axis A (a transverse direction extending perpendicularly to the radial axis). More specifically, the inner surface 16b extends substantially parallel to the radial axis A over a first portion 16b1 from the opening 16a, then forms a second convergent portion 16b2 (here in the manner of a funnel with an overall frustoconical shape neck followed by a terminal portion substantially parallel to the axis A) narrowing the space inside the socket away from the opening 16a (in the direction of the axis X-X′). This shrinking forms a stop along the radial axis A for the module (device 24), in the direction of the inside of the hub (in the direction of the axis X-X′).

The device 24 comprises an assembly formed of at least two ball bearings:
an outer bearing 26 (first bearing) disposed, in relation to the radial axis A, in a transverse position which is the furthest from this axis, and
an inner bearing 28 (second bearing) disposed in a transverse position which is the nearest to the radial axis A with respect to the outer transverse position of the outer bearing 26. Note that the concept of the outside and inside of the bearings also refers directly to the position of each of these bearings with respect to the central longitudinal axis X-X′ insofar as the outer bearing 26 is located in a radially outward position in relation to the radially inward position of the lower bearing 28.

The outer bearing 26 is configured to take up the radial forces (along the radial axis A) and transverse forces (along a transverse axis perpendicular to the radial axis A) transmitted by the blade during the operation of the fan (rotation about the axis X-X′) and is disposed in a radial position (along the radial axis A) which is further from the longitudinal axis X-X′ than the radial position of the inner bearing 28. The inner bearing 28 is configured to take up the transverse or tangential forces transmitted by the blade during operation of the fan, while the outer bearing 26 is of greater dimensions than the inner bearing 28 insofar as it is configured to take up radial forces along the radial axis A (forces due to the centrifugal force) which are the greatest forces to which the device 24 is subjected during the rotation of the blade. Note that the devices 24 are mounted radially in star configuration with respect to the hub 14 in such a way that the orientation of each device 24 in space varies as a function of the angular position of the hub socket under consideration.

As more specifically shown on FIG. 3, the outer bearing 26 includes an outer bush 26a, an inner bush 26b and ball bearings 26c clamped jointly by the two bushes.

Similarly, the inner bearing 28 includes an outer bush 28a, an inner bush 28b and ball bearings 28c clamped jointly by the two bushes.

The outer bush 26a of the outer bearing 26 is disposed in an outer transverse position which is further from the socket radial axis A than the transverse position of the rolling bearings 26c and 28c of the outer 26 and inner 28 bearings. The outer bush 26a extends substantially radially to the radial axis A along the rolling bearings 26c of the outer bearing and descending along the outer bush 28a of the inner bearing 28, and bears against this outer bush 28a. Note that the outer bush 26a extends downward (in the direction of the inner bearing) along the profile of the inner surface 16b of the socket with which it is in contact, i.e. by first taking a substantially straight portion 26a1, then narrowing in such a way as to take a convergent portion 26a2 (a neck forming a frustoconical portion followed by a straight portion). A clamping element 32 of the inner bearing 28 can be disposed in an outer transverse position in relation to the inner bearing 28 and the narrowed lower part 26a2 of the outer bush 26a of the outer bearing 26 bears on this clamping element. This clamping element ensures a preloading or prestressing of the inner bearing 28.

This clamping element 32 is for example a clamping nut screwed onto the inside of the outer bush 26a of the outer bearing 26. For example, a key 34e and a circlip 34f can be used to ensure that the clamping element 32 does not become unclamped (from the top, i.e. level with the socket opening 16a), as described further on (although other members ensuring that the element 32 does not become unclamped may alternatively be envisioned.)

The device 24 also comprises an intermediate interface part 30 disposed between, on the one hand, the outer 26 and inner 28 bearings (the part 30 is clamped between the two bearings 26, 28) and, on the other hand, the blade root 22 and extends along the radial axis between a radially outward position and a radially inward position. The part 30 is part of the block 24 and serves as mechanical interface with the blade root 22. Such an interface makes it possible to avoid wearing the bearing bushes if they were directly in contact with the blade root 22. In the device 24 described above, the inner bearing 28 is housed in the outer bush of the outer bearing 26, as well as the intermediate interface part 30 which makes it possible to link the inner bushes 26b and 28b together and to provide a support for the blade root 22, thus making it possible to form a “cartridge” containing the rolling bearings and the intermediate interface part 30 and being able to be handled as a single block (as a single piece) by an operator wishing either to install the device 34 in a hub socket (from the outside of the hub), or to remove it (still from the outside).

The inner bush 26b, 28b of each of the outer and inner bearings is disposed in an inner transverse position in relation to the outer transverse position of the rolling bearings 26c, 28c of each bearing which is further from the radial axis A than that of the inner bushes. Each inner bush is housed in a housing 30a, 30b for which provision is made on an outer surface of the intermediate interface part 30. More specifically, the part 30 includes, on its outer surface oriented in the direction of the rolling bearings 26c, 28c of each bearing, an outer peripheral collar 30c which delimits above and below it (on FIG. 3) an upper space and a lower space to respectively receive the inner bushes 26b and 28b. The interface part 30 is drilled in its central part to axially receive (along the radial axis A) the blade root 22, which includes an elongated part extending along the radial axis and includes an inner stop element 30d serving as axial stop along the radial axis for the blade root 22. The blade root 22 includes, on its outer surface intended to come into contact with the blade force take-up device, and particularly with an inner surface of the interface part, an engagement part 22c (e.g. outer shoulder) of complementary shape bearing on the inner axial stop element 30d. As shown on FIG. 3, the inner axial stop element 30d is formed by the upper end (radially outward position) of the interface part 30 which here forms an annular rim. To interact with this inner axial stop element, the outer shoulder 22c of the blade root 22 which extends transversally in relation to the elongated overall shape of the blade root can take the form of an annular collar.

The blade force take-up device 24 may also comprise a system 34 for retaining in position, and clamping by wedge effect, the assembly of rolling bearings 26, 28 inside the hub socket 16.

This system 34 is for example positioned substantially level with the socket opening 16a (after the device 24 has been put in place in the socket), in a radial position (along the radial axis A) which is further from the longitudinal axis X-X′ (radially outward position) than the outer bearing 26 (radially inward position). On FIG. 3, the system 34 is disposed above the bearing 26.

The system 34 for retaining in position and clamping by wedge effect is, for example, a system of keystone type which clamps the bearing cartridge against the inner surface 16b of the socket. Such a system 34 for example comprises two segments in two half-shells 34a-b, clamping parts 34c (distributed circumferentially to and inwardly of the segments), a clamping nut 34d, as well as an anti-rotation key 34e and a circlip 34f. The segments 34a-b and the clamping parts 34c ensure the retainment in the radial position (along the radial axis A) of the bearing cartridge and its clamping against the inner surface 16b of the hub socket (along a transverse direction with respect to the radial axis A and away therefrom). The segments 34a-b and the outer part of the clamping parts 34c with which the segments interact are in particular housed in an annular groove 16c fashioned in the thickness of the wall of the hub socket. The clamping nut 34d, the anti-rotation key 34e and the circlip 34f thus ensure the retainment in the radial position of the segments 34a-b and clamping parts 34c. More specifically, the two segments 34a-b and the clamping parts 34c have opposing respective conical mating surfaces (the inner conical surface portions, for the segments, and the opposing outer conical surface portions, for the clamping parts, are each oriented on a cone, the apex of which is positioned on the axis A away from the central axis X-X′, i.e. the cone is open in the direction of the central axis X-X′) which are retained bearing against one another owing to the clamping force incurred by the nut 34d on the clamping parts 34c (the nut has an inner conical surface portion which bears on each of the inner conical surface portions of the clamping parts, the conical surface portions being each oriented on a cone, the apex of which is positioned on the axis A in the direction of the central axis X-X′, i.e. the cone is open away from the central axis X-X′). Note that other types of mounting can be used to fulfil the same function.

In order to ensure the locking of the blade root in the blade force take-up device 24, a device for clamp-locking 50 the blade root 22 is put in place in a radially outer area of the device 24, substantially level with the socket radial opening 16a.

The device 50 for clamp-locking the blade root 22 is positioned around this latter, in a radially outward position with respect to the radially inward relative position of the inner stop element 30d of the interface part 30. This device 50 is attached to the blade force take-up device 24 in such a way as to clamp the blade root and to retain it axially stopped against the inner stop element 30d.

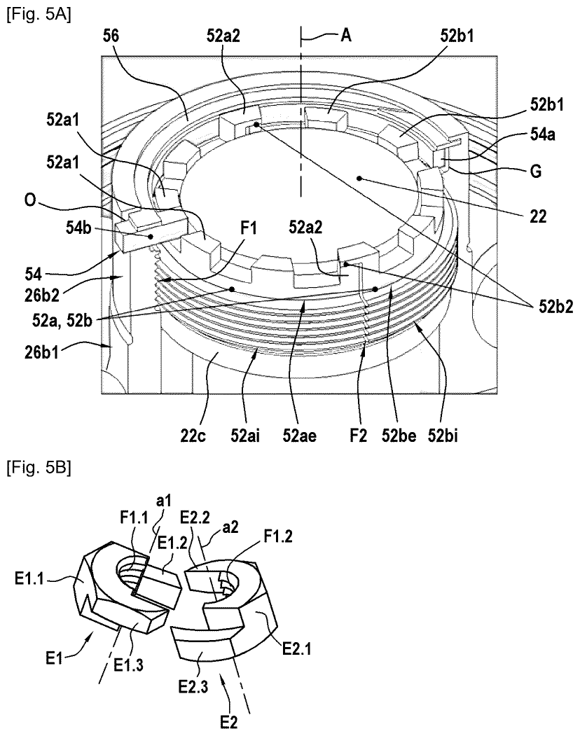

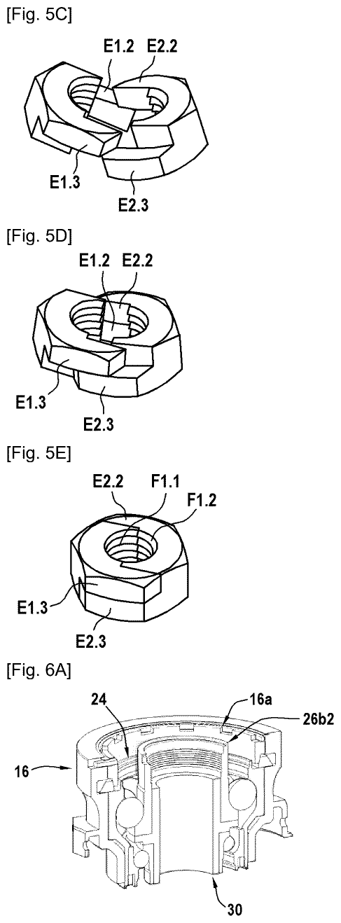

FIG. 4 is a magnified and partial view showing along a half-section, in perspective, the inside of the hub socket on which the front part of the rolling bearings has been removed to make the intermediate part 30 and the components of the locking device 50 visible. FIG. 5A, meanwhile, is a similar view to that of FIG. 4 but with the blade root 22 truncated at its upper part.

As shown on FIG. 3 and more specifically on FIGS. 4 and 5A, the inner bush 26b of the outer bearing 26 extends along the radial axis A and comprises, on the one hand, a first part 26b1 in contact with an outer surface, opposite the inner surface, of the intermediate interface part 30 and, on the other hand, a second part 26b2 which extends away from the longitudinal axis X-X′ all the way to a radially outward position in relation to a radially inward position occupied by the transversal extension part or shoulder 22c of the blade root when this latter is engaged against the inner axial stop element 30d. Note that the radially outward position of the second part 26b2 is disposed substantially level with the opening 16a of the hub socket and therefore beyond the assembly of rolling bearings (the second part 26b2 axially extends the inner bush in the direction of the opening 16a).

More specifically, the clamp-locking device 50 is configured to be clamp-locked onto the second part 26b2 in such a way as to bear, by clamping, along the radial axis against the transverse extension part or shoulder 22c of the blade root.

In this exemplary embodiment, the second part 26b2 has an inner thread F1 on an inner surface of the inner bush which is oriented facing the blade root 22 (the inner bush surrounds the blade root). The clamp-locking device 50 meanwhile comprises a clamping nut 52 in two parts 52a, 52b disposed between the second part 26b2 and the blade root 22 on FIGS. 3 and 4 when it is in place. The clamping nut 52 is provided with an outer thread F2 which is screwed onto the inner surface of the second part 26b2 by way of the two complementary threads F1 and F2, in such a way that the clamping nut 52 then bears, when fully tightened on the inner surface of the second part 26b2, along the radial axis against the transverse extension part or shoulder 22c of the blade root 22. More specifically, as shown in FIGS. 3 and 4, the clamping nut 52 bears, when fully tightened, against an upper (radially outer) face of the shoulder 22c, opposite the lower (radially inner) face of this shoulder which is bearing on the inner stop element 30d.

As shown on FIGS. 4 and 5A, the part 52a (resp. 52b) of the clamping nut 52 includes a plurality of teeth 52a1 (resp. 52b1) spaced apart from one another and which extend around a half-circumference of the clamping nut taken transversally with respect to the radial axis A, when the two parts 52a, 52b meet one another. The teeth 52a1 (resp. 52b1) are more specifically fashioned in a portion 52ae (resp. 52be) of the part 52a (resp. 52b) which is located at a radially outward position (upper portion on FIGS. 4 and 5A) in relation to a portion 52ai (resp. 52bi) of this part 52a (resp. 52b) which is located at a radially inward position (lower portion on FIGS. 4 and 5A) and which then bears, along the radial axis A, against the transverse extension part or shoulder 22c of the blade root 22. The radially inward portion 52ai (resp. 52bi) of the part 52a (resp. 52b) of the clamping nut 52 bears, more specifically, against the upper (radially outward) face of the shoulder 22c. The radially inward portion 52ai (resp. 52bi) of the part 52a (resp. 52b) has a part of the outer thread F2 of the nut 52. The teeth of the nut 52 thus form, as shown on FIGS. 4 and 5A, a crenellated upper free edge.

Each part 52a, 52b thus bears a part of the teeth of the clamping nut 52 and forms a half-nut which is here akin to a half-cylinder in section along its axis of revolution. Note however that the clamping nut can take other forms; in particular, the two component parts of this nut may take different forms which are not necessarily each akin to one half-cylinder.

According to a variant illustrated in FIGS. 5B to 5E, the clamping nut is formed of two half-nuts E1 and E2 which differ from two half-cylinders. The first (resp. second) half-nut E1 (resp. E2) includes a central part E1.1 (resp. E2.1) of cylindrical inner shape provided with an inner half-thread F1.1 (resp. F1.2). The first (resp. second) half-nut E1 (resp. E2) includes two arms E1.2, E1.3 (resp. E2.2, E2.3) which extend from the central part E1.1 (resp. E2.1) and which are each located in a different transverse plane, taken in relation to the axis of revolution a1 (resp. a2) of the cylindrical inner shape of the central part E1.1 (resp. E2.1). The two half-nuts E1 and E2 have identical configurations which, when the two half-nuts face one another, allow the two arms of one half-nut to interlock with the two arms of the other half-nut, as illustrated on the different FIGS. 5B-5E. Thus, the arm E2.3 is then housed under the arm E1.3 and the arm E1.2 is then housed under the arm E2.2, thus allowing an interlocking of the two half-nuts E1 and E2 to form the clamping nut of FIG. 5E in which the two inner half-threads F1.1 F1.2 have met to form the full inner thread. However, the use of this clamping nut variant in the embodiment of FIGS. 4 and 5A requires the modification of its outer surface so that it has an outer thread similar to the inner thread F2 described above. Moreover, teeth are also fashioned in the top part of the nut to fulfil the function in relation with the mode of FIGS. 4 and 5A. This variant offers a large contact surface between the two half-nuts.

The clamp-locking device 50 clamping further comprises an anti-rotation member 54, such as an anti-rotation key, configured to prevent a rotation between the inner bush 26b and the clamping nut 52, more specifically one of the two parts of the nut. In this example, the anti-rotation member 54 is particularly disposed between two consecutive teeth, for example two teeth 52a1 of the part 52a.

As shown more specifically on FIG. 5A, the anti-rotation member 54 takes the form of a ring 54a equipped with a finger 54b disposed transversely with respect to the radial axis A. The finger 54b extends inwardly and outwardly along a transverse direction with respect to the circumference of the ring 54a in such a way as to be able to be inserted simultaneously between two consecutive teeth of the nut 52 and into an opening O formed in the second part 26b2 of the inner bush.

Note that, according to a variant (not shown), the teeth and the anti-rotation member can be replaced by any other mechanical structure fulfilling the same function of relative rotational locking between the inner bush and the blade root.

Moreover, the clamp-locking device 50 may further comprise a stop member 56 which retains the anti-rotation member 54 in position between two consecutive teeth, while being attached to the second part 26b2 of the inner bush 26b in proximity to its upper radial position. This stop member 56 for example here takes the form of a retaining ring or circlip which extends above the anti-rotation key, against the ring 54a of this latter, while being partially inserted into a groove G for which provision is made in the inner surface of the second part 26b2, near the upper (radially outer) end of this second part, substantially level with the socket radial opening 16a.

Moreover, the clamping nut 52 in two parts 52a, 52b includes aligning elements 52a2, 52b2, such as hooks, configured to ensure the alignment in the radial position of the two parts 52a, 52b of the nut with respect to one another in order to ensure the alignment of the two portions of the outer thread F2 for which provision is made on the two parts of the nut.

On FIG. 5A, the hooks 52a2, 52b2 are formed in part by tooth portions 52a1 of the part 52a and tooth portions 52b1 of the other part 52b each configured to interlock one inside the other at the two diametrically opposed junction areas of the two parts 52a, 52b along a circumferential direction. More specifically, a tooth portion 52b2 of a part 52b is inserted under a tooth portion 52a2 of a part 52a and, in a diametrically opposed manner, a tooth portion 52a2 of the part 52a is inserted under a tooth portion 52b2 of the part 52b as shown on FIG. 5A. Such an arrangement therefore makes it possible to thus fix the radial position of each of the two parts of the clamping nut with respect to one another, which makes it possible to align with one another the two outer thread portions of the outer thread F2. Note that other means of alignment of the outer thread portions of the two parts of the clamping nut may be envisioned such as for example an interlocking of tenon and mortice type at the two diametrically opposed areas of the two parts of the clamping nut in contact with one another, in the areas of these parts which are located below the teeth.

When the blade mounting module is put in place in the hub socket 16, the device 24 (bearing cartridge) is inserted beforehand through the radial opening 16a in the hub socket 16 in such a way as to be positioned bearing against the inner surface 16b of the socket. The system 34 described above is put in place through the top, component element by component element, starting with the segments 34a-b which are inserted into the angular groove 16c internal to the socket, for example near its opening 16a, the clamping parts 34c which bear inwardly along a conical mating surface against the conical inner faces of the segments, then the clamping nut 34d, the anti-rotation key 34e and the circlip 34f. The device 24 is thus clamped against the inner surface 16b of the socket, along a transverse direction perpendicular to the axis A.

In general, the blade root 22 is then introduced into the socket from the top (from the outside of the socket) and is more specifically force-inserted into the interface part 30 to arrive at the installed position of FIGS. 3 and 4. As shown on these figures, the blade root 22 is translationally stopped, in a first direction (here descending), by the inner stop-forming element 30d of the interface part 30.

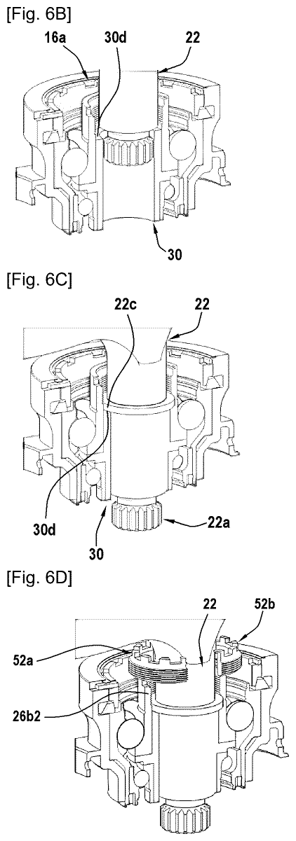

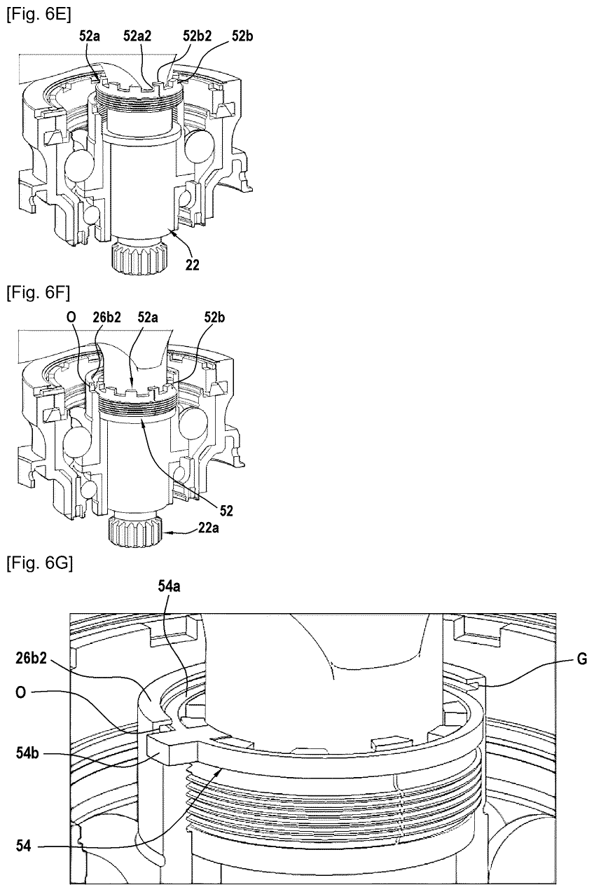

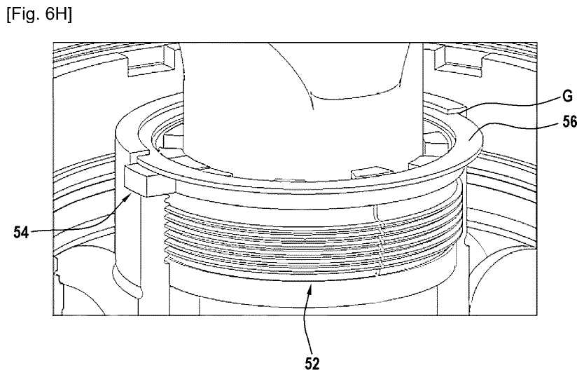

FIGS. 6A-H more specifically illustrate the assembly block diagram of the blade root 22 and of the device 50 for locking this latter with respect to the blade force take-up device 24 previously installed in the hub 16 socket 16a.

FIG. 6A shows the blade force take-up device mounted inside the hub socket 16 socket 16a, waiting to receive the blade root 22 (or the blade support according to another embodiment already described above).

FIG. 6B shows the blading, of which only the blade root 22 appears above the socket radial opening 16a. The blade root 22 is disposed concentrically with the interface part 30 and the blade root is inserted axially (along the radial axis A) inside the interface part 30 (descending movement on the figure) until the shoulder 22c of the blade root 22 bears (axial stop) against the peripheral border 30d (inner stop element) of the interface part 30 (FIG. 6C).

As shown on FIG. 6D, the two parts or half-nuts 52a and 52b of the clamping nut 52 are positioned around the blade root 22 (around a cylindrical portion of the root), above the second part 26b2 of the inner bush 26b, in such a way as to then clamp around the blade root.

As shown on FIG. 6E, the hooks of the two parts 52a and 52b of the clamping nut 52 described in relation to FIG. 5A are put in contact by interlocking them with one another in order to obtain the radial alignment of the two parts (and therefore of the two outer thread portions forming the outer thread F2) illustrated on the magnified view of FIG. 5A.

On FIG. 6F the two parts 52a, 52b of the clamping nut are screwed onto the second part 26b2 of the inner bush by way of the respective corresponding outer F2 and inner F1 threads to the desired torque (when fully tightened). During this operation one also makes sure that one of the spaces or notches between two consecutive teeth of the clamping nut 52 is positioned facing the opening O formed in the second part 26b2 of the inner bush.

FIG. 6G is a partial magnified view of the variable-setting assembly of FIG. 6F and shows the putting in place of the anti-rotation member 54, with the ring 54a positioned between the second part 26b2 and the teeth of the clamping nut and the locking finger 54b inserted into the space or the notch between two consecutive teeth which has been previously positioned facing the opening O, as described above in relation to FIG. 6F.

Next, as shown in FIG. 6H, the stopping member 56 (e.g. circlip) is put in place in such a way as to crown the anti-rotation member 54 by being fixed onto the second part 26b2 of the inner bush in order to lock the assembly and secure it to the bush 26 and therefore to the blade force take-up device 24. More specifically, the stop member 56 is partially inserted into the inner groove G of the second part 26b2 and bears along the radial axis A on the anti-rotation member 54, thus pressing this latter flat against the clamping nut 52.

Owing to this assembly and this locking system, the blade root 22 is thus retained axially (along the axis A) in a second opposite direction (here ascending) inside the blade force take-up device in the hub socket.

As soon as the blade root 22 is locked in the device 24 (bearing cartridge) as explained above with reference to FIGS. 6A-H, the engagement part 44b of the eccentric system is engaged with the lower opening-out or protruding part 22a of the blade root 22. In this example, the inner splines of the engagement part 44b are then inserted between the outer splines of the lower part 22a to obtain an engagement position (meshed position) which will subsequently make it possible to control the desired pivoting of the blade root for a given setting of the blade.

Note that to perform a maintenance operation on the variable-setting assembly described above, particularly on a blade, it suffices to unlock the blade root from the blade force take-up device 24 by performing, on the locking device 50, the reverse operations to those described with reference to FIGS. 6A-F. To remove the blade root 22 from the device 24 and therefore from the hub socket 16, it is not necessary to access the inside of the hub as in the prior art since it suffices to axially remove the blade root 22 upward (to go from the position of FIG. 6C to that of FIG. 6B) to disengage the lower part 22a from the engagement part 44b of the eccentric system.

The device 50 for locking the blade root in the blade force take-up device 24 as described above can take other forms than those illustrated and can in particular be applicable to a blade force take-up device of different structure. The blade force take-up device to which the device for locking the blade root can be applicable generally has an intermediate/inner interface part between the blade force take-up device and the blade root, as well as an outer bush which is concentric with this intermediate interface part and onto which the locking device can be fixed.

Moreover, the fan includes in a known manner, in its upstream part (on the left on FIG. 2), an aerodynamic cone 46 (“spinner”) forming a cowl enclosing, in particular, the fan blade mounting modules and the blade support pivot control mechanism. The fan also includes, inward of the cone 46, an inner cowl 48. In a known manner, the blades of the fan extend radially beyond the cone 46 in order to be exposed to the air flow path surrounding the cone.

Although this description refers to specific exemplary embodiments, modifications may be made to these examples without departing from the general scope of the invention as defined by the claims. Moreover, individual features of the different embodiments illustrated or mentioned may be combined into additional embodiments. Consequently, the description and the drawings must be considered in an illustrative sense rather than a restrictive one.

1. A variable-setting assembly for a turbomachine fan, comprising:
a hub extending circumferentially around a longitudinal axis of rotation of the hub and which comprises at least one hub socket internally delimiting an opening oriented radially in relation to the longitudinal axis,
a fan blade force take-up device which is attached in said at least one hub socket and intended to take up the forces of a fan blade mounted in said at least one hub socket,
a fan blade support or a fan blade root which is able to pivot on command about a radial axis passing through the radial opening of the hub socket and configured to be engaged through this opening, inside the blade force take-up device, and to then abut along the radial axis against an inner element the blade force take-up device,
a device for clamp-locking the blade support or the blade root which is positioned around this latter, at a radially outward position with respect to a radially inward position, nearer to the longitudinal axis, of the inner stop element, and which is attached to the blade force take-up device in such a way as to clamp around the blade support or the blade root and to retain it abutting along the radial axis against the inner stop element,
the blade force take-up device comprising an intermediate interface part which extends along the radial axis between a radially outward position and a radially inward position and which includes, at its radially outward position, the inner stop element, the blade support or the blade root including, on the one hand, an elongated part which extends along the radial axis and which is disposed against at least one radial axis extension part of an inner surface of the intermediate interface part and, on the other hand, a part which extends transversely in relation to the radial axis and which is engaged against the inner stop element, the blade force take-up device comprising an assembly formed of at least one rolling bearing in a radially outward position and a second rolling bearing in a radially inward position, the first bearing including an inner bush which extends along the radial axis and the second bearing including an inner bush which extends along the radial axis, the intermediate interface part being clamped between the inner bushes of the two bearings.

2. The assembly as claimed in claim 1, wherein the hub extends circumferentially around a longitudinal axis of rotation of the hub and comprises a plurality of hub sockets circumferentially distributed over an outer periphery of the hub, each hub socket internally delimiting an opening oriented radially in relation to the longitudinal axis and which is able to put a peripheral area radially outward of the hub socket, located away from the longitudinal axis, in communication with a peripheral area radially inward of the hub socket, which is nearer to the longitudinal axis, a blade force take-up device being configured to be put in place in each hub socket through the opening of this latter, and clamped against an inner surface of the hub socket disposed substantially parallel to a radial axis passing through the radial opening of the hub socket.

3. The assembly as claimed in claim 1, wherein the inner bush of the first bearing comprises a part extending in a radially outward position and onto which the clamp-locking device is clamp-locked, the part of the inner bush having an inner thread on an inner surface oriented facing the blade support or the blade root, the clamp-locking device comprising a clamping nut in two parts disposed between the part of the inner bush and the blade support or the blade root, which is provided with an outer thread and is screwed onto the inner surface of the part of the inner bush by way of the two threads.

4. The assembly as claimed in claim 3, wherein the clamp-locking device further comprises an anti-rotation member configured to prevent a rotation between the inner bush and the clamping nut.

5. The assembly as claimed in claim 4, wherein the two parts of the clamping nut each include a plurality of teeth spaced apart from one another, the anti-rotation member being disposed between two consecutive teeth.

6. The assembly as claimed in claim 1, wherein the clamping nut in two parts includes elements configured to ensure the alignment in the radial position of the two parts of the nut, one with respect to the other in order to ensure the alignment of the portions of the outer thread provided on the two parts of the nut.

7. The assembly as claimed in claim 1, wherein the blade force take-up device comprises a system for retaining in position, and clamping by wedge effect, the rolling bearing assembly that is positioned level with the socket opening, in a radial position further from the longitudinal axis than the first rolling bearing.

8. The assembly as claimed in claim 1, wherein a clamping element of the second rolling bearing is disposed in an outward transverse position in relation to this second bearing and the outer bush of the first rolling bearing bears on this clamping element.

9. The assembly as claimed in claim 1, wherein it includes an eccentric system for controlling the pivoting of the blade support or of the blade root which is configured to control the pivoting of the blade support or of the blade root about the socket radial axis A, the system including an engagement part configured to be engaged in an engagement position with a lower part of the blade support or of the blade root which is opposite an upper part of the blade support disposed in a radially outward position in relation to the radially inward position of the lower part.

10. A turbomachine fan, characterized in that it comprises a variable-setting assembly for a turbomachine fan as claimed in claim 1.

11. turbomachine comprising a fan as claimed in claim 10.
